(19) United States
(12) Patent Application Publication
(10) Pub. No.: US 2007/0211179 A1
(43) Pub. Date: Sep. 13, 2007

(54) COLOUR DISPLAY DEVICE

(75) Inventors: Jason R. Hector, Redhill (GB); Alan G. Knapp, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,616

(22) PCT Filed: May 6, 2005
(86) PCT No.: PCT/IB05/51485

§ 371 Date: Nov. 3, 2006

(30) Foreign Application Priority Data
May 8, 2004 (GB) 0410327.1

(51) Int. Cl. H04N 9/31

(52) U.S. Cl. 348/744

(57) ABSTRACT

A field sequential colour display device has a light source arrangement (16) for providing at least two outputs (R, G, B) in sequence of different colour spectrum. The light source output intensity is controlled independently for each output; in dependence on analysis of the data for an image to be displayed. The brightness of each backlight colour output is thus adapted as a function of the image content, and this enables power savings to be obtained.

This invention relates colour display devices, and particularly to field sequential colour display devices. These display devices provide a colour output by dividing a field into a plurality of sub-fields, and displaying a different colour image in each sub-field. The different sub-fields are integrated in the eye of the display user to form a full colour image.

Several types of field sequential display device are known. One possible way to provide multiple colour light source outputs is to provide a single white light source, and to generate different colours using filters. This may require mechanically moving filters, which is not desirable.

A preferred system has a colour light source arrangement that emits red, green, and blue light, using red, green and blue light emitting diode devices. Only recently have high-emission blue LEDs been developed, and for this reason there is now an increasing interest in the development of field sequential colour displays.

In operation of such a device, the backlight flashes red, green and blue in turn. Each pixel is used to modulate each colour in turn. In conventional systems, the backlight is flashed with a substantially constant brightness over time. From frame to frame, the brightness in each colour can, however, be varied to ensure a good white point for the display. Various techniques have been proposed for controlling the white balance of a colour field sequential display.

There is a continuous desire to reduce the power consumption of display devices, particularly when they are to be used in battery-operated products, such as portable devices. It has been proposed to alter the overall backlight intensity as a function of the average luminance of the image to be displayed, and to alter the pixel control signals accordingly, and this can reduce the power consumption of the backlight.

According to the invention, there is provided a field sequential colour display device, comprising:

a display pixel array;

a light source arrangement for providing at least two outputs in sequence of different colour spectrum;

control means for controlling independently the light source output intensity for each output; and

means for analysing the data for an image to be displayed, wherein the control means controls the light source output intensity for each output based on the analysis of the image data.

The invention is based on the recognition that some images do not require uniform brightness in each colour. For example, an image of grass contains plenty of green but little red or blue, and so some power is wasted by generating unnecessary light (red and blue light for the grass image) which is then absorbed by the display pixel.

The invention adapts the brightness of each backlight colour output as a function of the image content, and thereby enables power savings to be obtained.

The light source arrangement may be for providing at three colour outputs in sequence. The means for analysing the data is preferably then for determining a peak brightness of each colour corresponding to the three colour outputs. In this way, the maximum brightness required by that particular light source output can be determined. The display data is changed to reflect a change from the maximum brightness, and for this purpose means is provided for altering the data for an image to be displayed, and for supplying the altered data to display drive circuitry.

The light source arrangement preferably comprises a light emitting diode arrangement, having at least three different sets of diodes of different colours, integrated into a single array device. The three colour outputs may comprise red, green and blue.

The image data can be amended in response to a changed light source output by using a look up table or by implementing an algorithm.

The control means may comprise a light source driver circuit for each colour, the light source driver circuit implementing a scaling function in dependence on the data analysis. This scaling function is not likely to be linear, as it will take into account the relationship between the light source drive signal and the light source output intensity for the particular light source.

The light source output intensity for each colour output may be controlled by controlling a drive current for each colour output or an illumination time for each colour output.

The invention also provides a method of addressing a field sequential colour display device, the device comprising a display pixel array and a light source arrangement for providing at least two outputs in sequence of different colour spectrum, the method comprising:

receiving image data for an image to be displayed;

analysing the image data to determine the colour components corresponding to the at least two colour spectra of the light source arrangement;

determining the required light source output intensity for each output in response to the image analysis and altering the respective image data in response to the determined light source output intensity; and

driving the pixel array with the altered image data and the determined light source output intensity.

The invention also provides a computer program for performing the method of the invention.

An example of the invention will now be described in detail with reference to the accompanying drawings, in which:

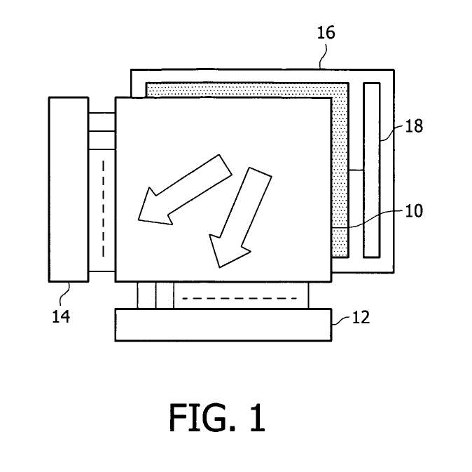

FIG. 1 shows schematically a display device to which the invention may be applied;

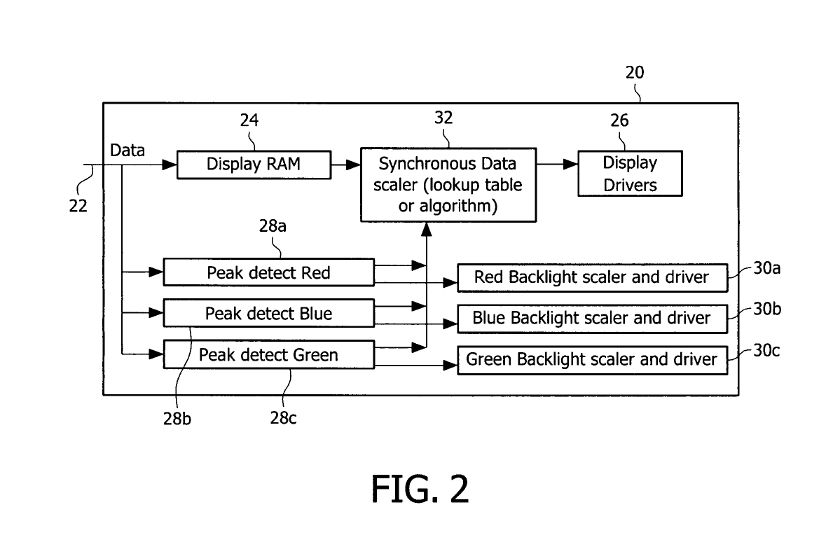

FIG. 2 shows one example of the additional hardware required to implement the invention; and

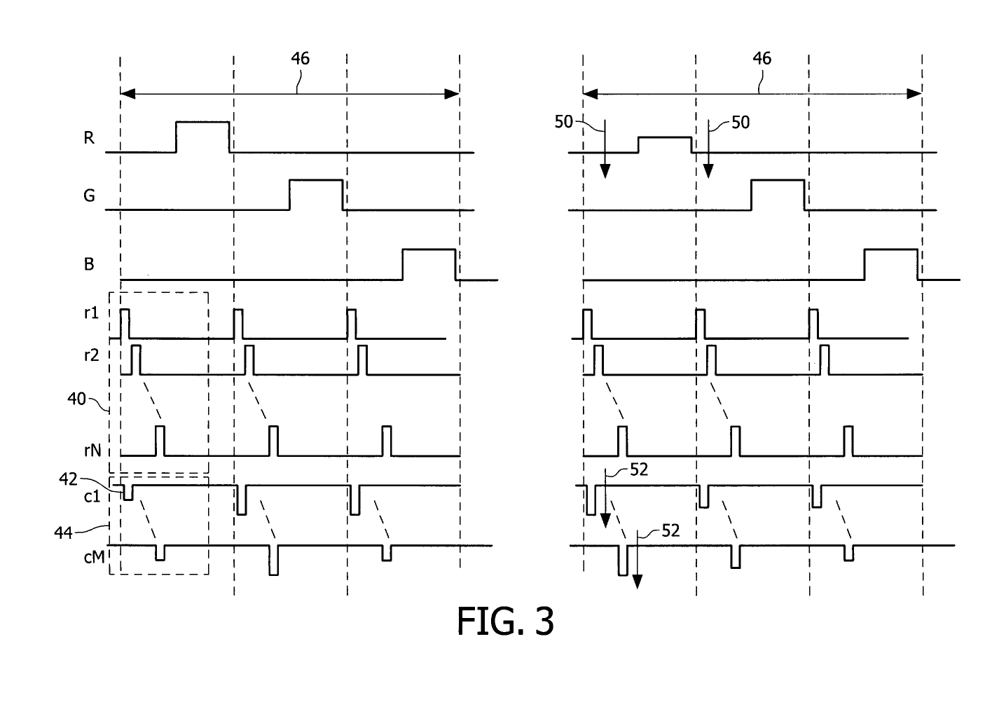

FIG. 3 is a timing diagram to illustrate the method of the invention.

This invention relates generally to display devices using backlights, and in which the backlight is driven to provide a number of different colours in a sequence. During each backlight flash, the pixel array of the display device is controlled to modulate the colour output at that particular time.

FIG. 1 shows a conventional active matrix liquid crystal display structure. The display is arranged as an array 10 of pixels in rows and columns. Row address signals are provided by row driver circuitry 12, and the pixel drive signals are provided by column address circuitry 14, to the array 10 of display pixels.

Each row of pixels shares a common row conductor, and each column of pixels shares a common column conductor. Each pixel comprises a thin film transistor and a liquid crystal cell arranged in series between the column conductor and a common electrode.

A backlight 16 provides illumination through the pixel array and is controlled by a light source driver circuit 18. The backlight comprises an array of light emitting diode elements, arranged in a pattern of three colours. (for example columns of the three colours or a grid of the colours).

In order to drive a liquid crystal cell to a desired voltage to obtain a required colour output, the liquid crystal cell of each pixel is charged to a desired voltage for each colour of the backlight, in turn. The operation and construction of a colour field sequential liquid crystal display will be well known to those skilled in the art.

The invention provides power savings by controlling independently the light source output intensity for each backlight colour output, based on an analysis of the image data.

FIG. 2 shows the additional circuitry required to implement the invention.

The invention provides an image and light source control unit 20, which receives the standard image data 22. This standard image data provides the pixel drive levels for an assumed maximum light source output intensity for each colour.

The data is stored in a field store 24 in the form of a RAM, and this enables the data to be analysed, and updated if required, before being used to control (conventional) display drivers 26.

The system 20 determines the peak intensity required for each colour, as shown schematically as blocks 28a, 28b and 28c. In practice, this determination will involve applying a simple algorithm to the image data. Based on the peak intensity for each colour required, the light source output is controlled independently by scaling and driving circuits 30a, 30b, 30c for each colour output of the backlight arrangement.

If the output intensity of a backlight can be reduced, the image data will need to be modified accordingly, so that no change in the viewed image results. For this purpose, a scaling unit 32 processes the image data before forwarding it to the display drivers 26, and this processing depends on the determined output levels for the backlight.

In this way, the invention provides power reduction by adapting the driving of the light source arrangement to ensure that, for each colour field where the peak brightness is less than the maximum, the display is driven to a higher transmission than in a standard display but at the same time the backlight brightness is reduced. This maintains the same perceived brightness but reduces the power required by the backlight. In particular, the correct colour and grey scale rendition are obtained.

The peak brightness data value for each colour determined from the image data corresponds to a known brightness for that colour.

By way of example, an image may contain a blue field with a mid-brightness green square, in which the peak brightness in the green is data value 31 (for 64 level 6-bit image data).

This value is the maximum transmission through the LC for the green sub-field and can thus be used to determine the brightness required in the green pulse from the backlight.

For a linear system, a peak brightness data level in a particular colour of 31 will enable the backlight brightness in that colour to be reduced by a factor 2. Similarly, if the peak brightness data level in a particular colour is 15, the backlight brightness could be reduced by a factor of 4.

As the image data is read out during addressing it is scaled to maintain image quality. In the example described above, with a peak brightness data value of 31, and a reduction by a factor of 2 of the backlight output for that colour, a pixel that has data value 31 for the colour of interest will be rescaled to data value 63.

In practice, a system will not be linear. Most displays have a power function relating the pixel drive voltage and the light transmission through the pixel, and the exponent is called the gamma value of the display. This gamma value is generally greater than one, and the function is also generally offset from the origin. There will in fact be an even more complex dependency of brightness on input drive signal. In practice, therefore, the scaling of the data and the brightness setting of the backlight flash intensity for each colour will be a more complex function. However, this function can be determined simply by testing or modeling at the design or manufacturing stage.

As shown in FIG. 2, a look up table or scaling algorithm can be used to implement the required relationship between backlight intensity reduction and pixel drive signal increase. The function or lookup table values can then be selected in order to ensure correct colour and grey scale rendition for the particular characteristics of both the light source and the pixel array.

The backlight LED brightness for each colour can be controlled either by adjusting the current through the LED or by adjusting the length of time of illumination of the LED.

FIG. 3 shows graphically the operation of one example of method of the invention.

The left part of FIG. 3 shows a conventional addressing scheme, and the right part of FIG. 3 shows how the addressing scheme is modified by the invention.

FIG. 3 shows the control signals R,G,B for the three colour outputs of the backlight. As shown, the three backlight colours are provided in sequence. Before each backlight illumination pulse, the full pixel array is addressed by applying a row address pulse r1-rN to each row in turn. Thus, block 40 shows the row address signals for each row of pixels. Each individual row address pulse is timed with a corresponding data signal c1-cM on the column conductors. During each row address pulse, data signals are provided to all columns simultaneously. Thus, each pulse 42 represents respective data signals provided to each column simultaneously, and block 44 represents column data signals for each column applied to all rows in sequence.

The pixel array is then fully addressed with the required red image data by the signals in blocks 40 and 42, and the backlight is then controlled to provide a red colour output. The field period 46 includes three sub-fields, one for each colour.

For the purposes of explanation, it is now assumed that all of the pixel data signals within the red sub-field (namely the signals within block 44) fall below a threshold value, for example less than 50% of the maximum pixel transmission.

The invention then provides scaling of the backlight red output intensity, to a reduced light-output intensity, thereby saving power. This is shown by arrows 50. In order to preserve the image, the data in the red sub-field is scaled in the opposite sense (to provide increased transmission of the reduced backlight output), as shown by arrows 52.

The range of brightness over which the scaling is applied can be limited to less than the full brightness range. For example, the backlight brightness may be varied by a range of only 4:1, so that once the peak data level for a given colour falls below a quarter of the maximum value (e.g. data level 15 in a 6 bit system, or 63 in an 8 bit system) no further adjustment of backlight brightness will occur. This has the advantage of giving a significant power reduction while allowing a relatively simple control system for the backlight.

Similarly, each backlight colour output can have a relatively small discrete number of different output levels, for example ¼, ½, ¾ and full brightness.

In the example above, the backlight illuminates the full display area all at once, for each colour output. However, the invention can be combined with a scanning backlight, for example a vertically scanning backlight. The scaling of the brightness value of the backlight could then be based on position in the display, and the pixel drive values for the relevant part of the display.

In the example above, the backlight provides three colours in sequence. There are other sequential illumination schemes to which the invention can be applied.

Colour field sequential backlight illumination provides an alternative to the use of colour filters to define different sub-pixel colours, and thus enables the full pixel resolution to be used for each sub-field colour. However, it is possible to combine multiple colour backlight outputs with colour filters, so that a pixel is again divided into sub-pixels.

For example one alternative scheme uses four colours; red, yellow-green, cyan and blue, and the backlight output comprises two of these colours at a time, in two sub-fields. Each pixel is divided into two areas using colour filters. In one sub-field, the yellow-green pixel component is output from one sub-pixel area and the blue pixel component is output from the other sub-pixel area. In the next sub-field, the cyan pixel component is output from one sub-pixel area and the red pixel component is output from the other sub-pixel area. In this way, only two sub-fields are required which gives more addressing time, and the pixels are divided into two (rather than three) sub-pixel areas, so that good resolution can be maintained.

This invention can be applied to any addressing scheme in which the pixel array is illuminated in two or more sub-fields, with different backlight output spectrum (i.e. colour or combination of colours). All of these possibilities are intended to be included within the term “field sequential”.

The additional hardware/software to implement the invention has been described above. The display structure can otherwise be conventional, as will be apparent to those skilled in the art. The implementation above enables standard row and column driver circuits to be used, and the invention simply provides pre-processing of the image data before using conventional driver circuitry. However, the invention can be implemented in many different ways. In practice, all of the functions will be implemented simply as software run by an appropriate processor, and which provides outputs to the backlight driver circuitry and the display drivers.

The display RAM may already be provided in a conventional display device for other purposes, and the invention will not then require an additional memory element.

The invention has been described above in connection with an LCD display. However, the invention can be applied to any display technology using backlight illumination.

Other variations and modifications will be apparent to those skilled in is the art.

1. A field sequential colour display device, comprising:
a display pixel array;
a light source arrangement for providing at least two outputs in 5 sequence of different colour spectrum;
control means for controlling independently the light source output intensity for each output; and
means for analysing the data for an image to be displayed, wherein the control means controls the light source output 10 intensity for each output based on the analysis of the image data.

2. A device as claimed in claim 1, wherein the light source arrangement is for providing at three colour outputs in sequence

3. A device as claimed in claim 2, wherein the means for analyzing the data is for determining a peak brightness of each colour corresponding to the three colour outputs.

4. A device as claimed in claim 2, wherein the three colour 20 outputs comprise red, green and blue.

5. A device as claimed in claim 1, wherein the light source arrangement comprises a light emitting diode arrangement.

6. A device as claimed in claim 1, further comprising:
display drive circuitry; and
means for altering the data for an image to be displayed and for supplying the altered data to the display drive circuitry, wherein the data is altered in dependence on the light source output intensity for each output.

7. A device as claimed in claim 6, wherein the means for altering comprises a look up table.

8. A device as claimed in claim 6, wherein the means for altering comprises a processor which implements an algorithm.

9. A device as claimed in claim 1, wherein the control means comprises a light source driver circuit for each light source output, the light source driver circuit implementing a scaling function in dependence on the data analysis.

10. A device as claimed in claim 1, wherein the control means controls the light source output intensity for each output by controlling a drive current for each output.

11. A device as claimed in claim 1, wherein the control means controls the light source output intensity for each output by controlling an illumination time for each output.

12. A method of addressing a field sequential colour display device, the device comprising a display pixel array and a light source arrangement for providing at least two outputs in sequence of different colour spectrum, the method comprising:
receiving image data for an image to be displayed;
analysing the image data to determine the colour components corresponding to the at least two colour spectra of the light source arrangement;
determining the required light source output intensity for each output in response to the image analysis and altering the respective image data in response to the determined light source output intensity; and
driving the pixel array with the altered image data and the determined light source output intensity.

13. A method as claimed in claim 12, wherein the light source arrangement is for providing at three colour outputs in sequence

14. A method as claimed in claim 13, wherein analysing the image data comprises determining a peak brightness of each colour corresponding to the three colour outputs.

15. A method as claimed in claim 12, wherein altering the respective image data comprises addressing a look up table.

16. A method as claimed in claim 12, wherein altering the respective image data comprises implementing an algorithm.

17. A method as claimed in claim 12, wherein 15 driving the pixel array with the determined light source output intensity comprises controlling a drive current for each output.

18. A method as claimed in claim 12, wherein driving the pixel array with the determined light source output intensity comprises controlling an illumination time for each output.

19. A computer program comprising computer program code means adapted to perform all the steps of claim 12 when said program is run on a computer.

20. A computer program as claimed in claim 19 embodied on a computer readable medium.
